(19) United States
(12) Patent Application Publication
(10) Pub. No.: US 2010/0132247 A1
(43) Pub. Date: Jun. 3, 2010

(54) ELECTRIC INSECT SWATTING APPARATUS HAVING A LIGHTING FEATURE

(76) Inventors: Cory Thomas Borovicka, San Francisco, CA (US); Charles Adams, Berkeley, CA (US)

Correspondence Address: BEESON SKINNER BEVERLY, LLP, ONE KAISER PLAZA, SUITE 750, OAKLAND, CA, 94612, US

(21) Appl. No.: 12/563,916

(22) Filed: Sep. 21, 2009

Related U.S. Application Data
(60) Provisional application No. 61/098,614, filed on Sep. 19, 2008.

(51) Int. Cl. A01M 3/02

(52) U.S. Cl. 43/137; 43/112; 43/113

(57) ABSTRACT

A racquet-shaped swatting apparatus for killing insects comprises a racquet head having a racquet frame and frame opening. Closely spaced electrical wires extend across the frame opening for intercepting and killing insects in flight, while a plurality of light sources are provided on the racquet head for illuminating flying insects. Preferably, the electrical wires of the racquet head frame and the racquet head light sources can be simultaneously activated by the user. The swatting apparatus is particularly adapted for use in low lighting environments.

### CROSS-REFERENCE TO RELATED APPLICATION

This application claims the benefit of U.S. provisional application Ser. No. 61/098,614 filed Sep. 19, 2008.

### BACKGROUND OF THE INVENTION

The present invention generally relates to devices for killing insects, and more particularly, to hand-held electric bug swatting devices.

Electric insect-killing devices are well known. Such devices kill flying insects that come into contact with electrified element or elements of the device. In one popular form, a hand-held insect swatter is provided in the form of a racquet shaped swatter having a racquet head and an elongated handle for gripping. The racquet head has a series of conductive wires, which, when electrified, carry a live voltage that is sufficient to kill insects that come into contact with the wires. Use of such swatting devices require that the user first see the insects and then position or swing the swatter so that the insects come into contact with the electrified racquet head wires. However, electric insect swatters are frequently used in the evening hours or under low lighting conditions where the insects are difficult to see. The present invention is directed to overcoming such use limitations, while uniquely providing a hand-held bug swatter capable of producing a light display that creates visual interest for the user and persons in the vicinity of the user.

### SUMMARY OF THE INVENTION

The invention involves a racquet-shaped swatting apparatus for killing insects, which has an lighting feature that can be activated by the user. The swatter has a racquet head comprised of a frame having a frame opening. Electrical wires extend across the frame opening for electrocuting insects that come in contact with the wires when the wires are electrified. A gripping handle extends from the racquet head for swinging, moving or positioning said racket head to intercept flying insects. The racquet head is provided with a plurality of light sources for illuminating insects in the vicinity of the racquet head as the racquet head is swung, moved or positioned. Switch means, preferably on the gripping handle, allow the user to operatively electrify the racquet head wires and to turn the racquet head light sources on and off. Preferably the racquet head wires and light sources are activated simultaneously by the switch means.

### DESCRIPTION OF THE DRAWINGS

FIG. 1 is a front elevational view of an electric insect-killing swatter in accordance with the invention.

FIG. 2 is a side elevation view thereof.

FIG. 2A is an enlarged, fragmentary cross-sectional view of the racquet head of the insect-killing swatter taken along line 2A-2A of FIG. 1.

FIG. 3 is a schematic drawing of an exemplary electrical circuit that can be used in the electric insect-killing swatter for activating both the electric wires and light source of the swatter's racquet head.

### A DETAILED DESCRIPTION OF THE ILLUSTRATED EMBODIMENT

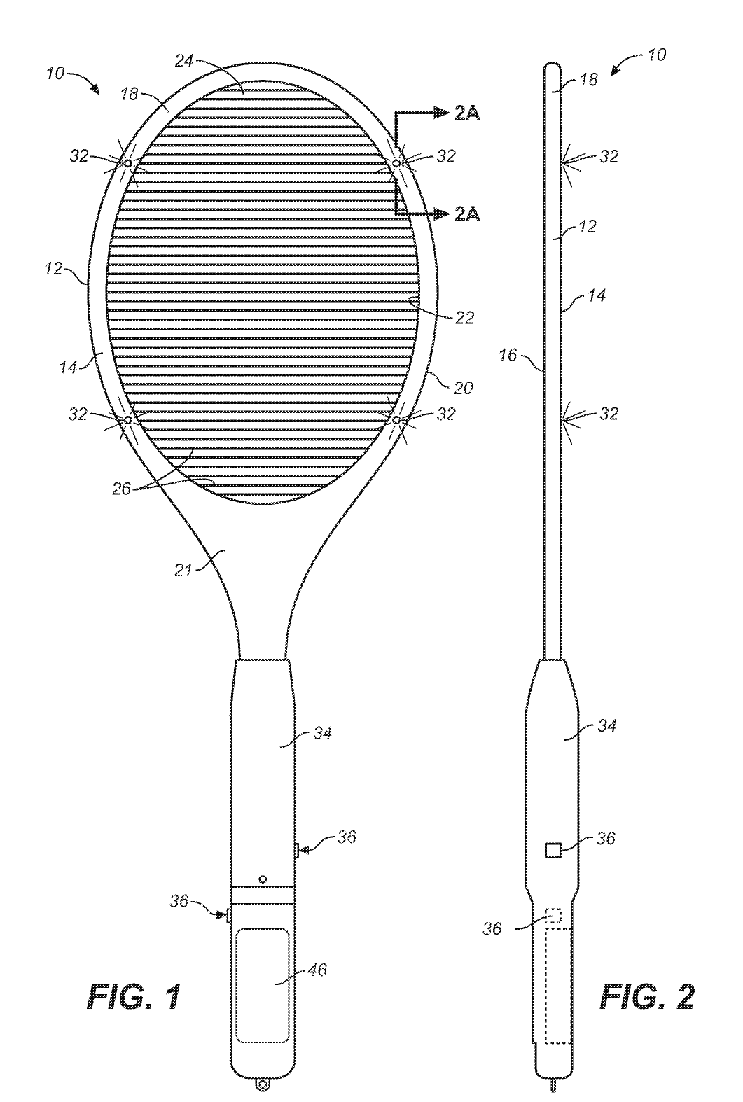

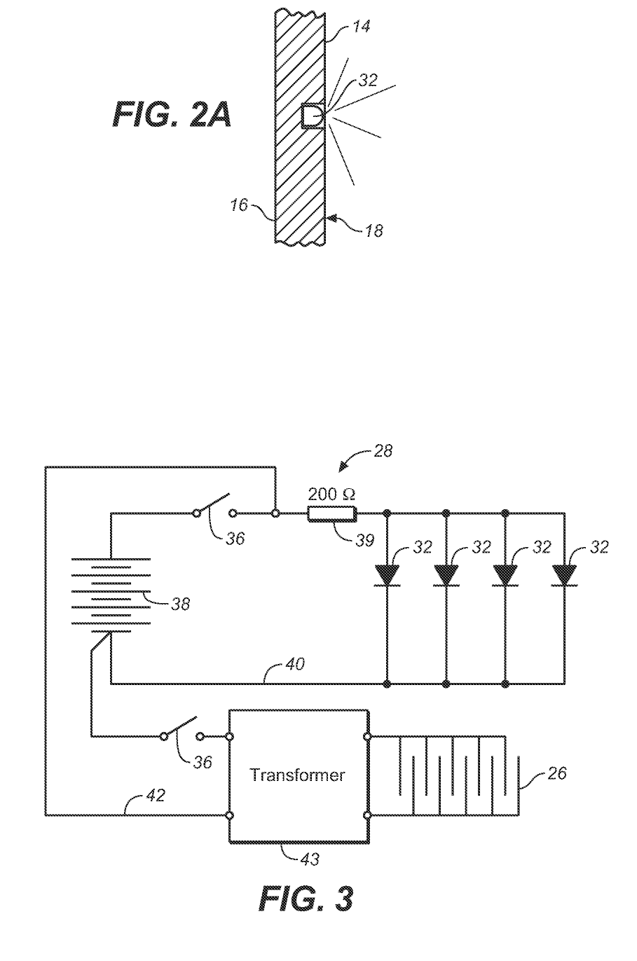

Turning now to the drawings, FIGS. 1 and 2 depict a racquet-shaped swatting apparatus in accordance with the invention. The apparatus 10 includes a racquet head 12 joined at its neck 21 to a gripping handle 34. The racquet head is of a desired size and shape, the shape preferably being oval like that of a tennis racquet, and includes a rigid frame 18 constructed of an insulating material such as plastic. The racquet head frame has a front and rear face 14, 16, an outer perimeter 20, and an inner perimeter 22, which defines a frame opening 24. Electrically conductive wires 26 extend across the frame opening 24 to form a closely spaced pattern of wires suited for intercepting insects whose flight path intersect with the racquet head. While the wires are shown as extending horizontally across the frame opening, it is understood that they could extend vertically or at an angle. As further described below, these wires can be electrified for killing insects that come into contact with the wires.

The lighting feature of the invention is provided by a plurality of light sources 32 located on the swatting apparatus, preferably on the racquet head 12. The light sources 32, which can be light emitting diodes (LEDs), are preferably positioned on the front face 14 of the frame 18 of the racquet head, and are preferably inset into the frame 18 as shown in FIG. 2A. Optionally, light sources may be positioned on the rear face 16 of the racquet head frame, or on both the frame's front and rear faces. This placement of the light sources will cause the emitted light to shine forward (and/or rearward) of the racquet head for illuminating insects in front of or to the rear of the racquet head as their flight paths approach the swatter. Additional light sources could also be provided on the gripping handle for enhanced lighting and visual effect.

In the illustrated embodiment, the swatting apparatus 10 has four light sources 32 symmetrically spaced about the front face 14 of the frame 18 of the racquet head. However, it will be understood that more or fewer light sources could be used and that the light sources could have an asymmetrical distribution; however, generally an symmetrical distribution is preferred. As described below, light source can be activated by the user so that they illuminate only when the swatter is in use.

The gripping handle 34, which extends from the racquet head, allows the user to swing, move or position the racquet head 12 so as to intercept flying insects. As shown in FIGS. 1-2, the handle 34 is elongated, suitably has a rectangular cross-sectional shape with rounded edges for comfortable gripping, and is suitably sized for gripping by the average adult-sized hand While it is possible for the handle 34 and racquet head 12 to be a monolithic structure, the gripping handle 34 will most suitably be a separate element, which is attached to the neck 21 of the racquet head 12 by any number of known securing or attaching means, such as, for example, by the use of screws. The gripping handle 34 will suitably be fabricated of a insulating material similar to the material used for fabrication of the racquet head 12.

A switch means is provided on the gripping handle 34 for activating and deactivating the electrical wires 26 of the racquet head. In the illustrated embodiment, the switch means is comprised of two button switches 36 positioned on opposite sides of the gripping handle 34. In a preferred embodiment, the button switches must be simultaneously pressed in order to activate the racquet head's electrical wires. To facilitate the simultaneous activation of the button switches with one hand, the switches are axially offset with respect to each other on the gripping handle.

In the preferred embodiment, the button switches 36 on gripping handle 34, in addition to being used to activate the racquet head wires 26, are also used to simultaneously activate the light sources 32. Thus, when the button switches are pressed, the racquet head wires will be charged and ready for killing insects, and the racquet head lights will at the same time come on. An exemplary circuit for accomplishing this is illustrated in FIG. 3. This battery operated circuit, which is generally indicated by the numeral 28, can suitably be housed within the gripping handle, which is provided a removable battery compartment cover 46 for inserting and removing batteries.

Referring to FIG. 3, the racquet head wires 26 are seen to be connected to a battery 38 through a circuit 42 that includes a transformer 43 and both of the button switches 36. Thus, the racquet head wires will not be electrified unless both switches are closed. The LED lights, represented by parallel connected diodes 32, are connected to the same battery through circuit 40, which includes one of the switches 36 and a series resistor 39 (suitably a 200 ohm resistor). The lights will come on if the switch in the LED circuit 40 is closed. If both switches are closed in order to electrify the racquet head wires, the lights will illuminate. The lights can also be activated without activating the racquet head wires by pressing the button switch in the LED circuit 40 without pressing the button switch in circuit 42. The implementation of this switch circuit, or variations thereof, would be well within the skill of an ordinary designer. Variations would include a circuit that incorporates a single switch or separate switches wherein either switch will activates the racquet head wires 26.

To use the illustrated insect swatting apparatus 10, the apparatus can be gripped by one hand using gripping handle 34. When an insect or insects are spotted, both of the button switches 36 can be pressed, one by the thumb of the gripping hand and the other by the forefinger. This will simultaneously turn on the light sources 32 and electrify the racquet head wires 26. With the aid of the light from the light sources, the racquet head can be swung, moved or positioned to intercept the flight path of the spotted insects. Swinging the racquet head with the lights on will also produce a visual light display for the user and persons in the vicinity of the apparatus.

It is therefore seen that the present invention provides a portable, hand-held electric insect-killing swatter with a lighting feature that enhances the visibility of insects in dark environments, and that produces a light display of visual interest. While the present invention has been explained in relation to its preferred embodiment, it is to be understood that various modifications thereof will be apparent to those skilled in the art upon reading this specification. Therefore, it is to be understood that the invention disclosed herein is intended to cover all such modifications as fall within the scope of the appended claims.

What I claim is:

1. A swatting apparatus for killing insects comprising:
a racquet head including a frame having an inner and outer perimeter and a front and rear face, the inner perimeter of said frame defining a frame opening, said racquet head further including electrical wires extending across said frame opening for electrocuting insects that come in contact with said wires when said wires are electrified;
a gripping handle extending from said racquet head for swinging, moving or positioning said racket head so as to intercept flying insects;
a plurality of light sources on said racquet head for illuminating insects in the vicinity thereof; and
switch means for activating said electrical wires of said racquet head.

2. The swatting apparatus of claim 1 wherein said plurality of light sources are positioned on at least one of the front and rear faces of the frame of said racquet head.

3. The swatting apparatus of claim 1 wherein said plurality of light sources are positioned on the front face of the frame of said racquet head.

4. The swatting apparatus of claim 1 wherein said plurality of light sources are positioned symmetrically about the frame of said racquet head.

5. The swatting apparatus of claim 1 wherein said plurality of light sources are LEDs.

6. The swatting apparatus of claim 1 wherein said switch means is located on said gripping handle.

7. The swatting apparatus of claim 1 wherein said switch means simultaneously activate the electrical wires of said racquet head and the plurality of light sources on said racquet head frame.

8. A swatting apparatus for killing insects comprising:
a racquet head including a rigid frame having an inner and outer perimeter and a front and rear face, the inner perimeter of said frame defining a frame opening, said racquet head further including electrical wires extending across said frame opening for electrocuting insects that come in contact with said wires when electrified,
an elongated gripping handle extending from said racquet head for swinging, moving or positioning said racket head so as to intercept flying insects,
a plurality of light sources on the front face of said frame of said racquet head for illuminating insects in front of said racquet head, and
switch means on said gripping handle for simultaneously activating the electrical wires of said racquet head and the plurality of light sources on the front face of said racquet head frame.

9. The swatting apparatus of claim 8 wherein said plurality of light sources includes at least four light sources on the front face of said racquet head frame.

10. The swatting apparatus of claim 9 wherein said at least four light sources are positioned symmetrically about said racquet head frame.

11. The swatting apparatus of claim 8 wherein said plurality of light sources are inset into the front face of said racquet head frame.

12. The swatting apparatus of claim 11 wherein said plurality of light sources include LEDs.

13. An electric insect-killing apparatus comprising
a racquet head including electrical wires for electrocuting insects that come in contact therewith when the wires are electrified;
gripping means extending from said racquet head for swinging, moving or positioning said racket head to intercept a flying insect;
a plurality of light sources on said racquet head for illuminating insects in the vicinity of said racquet; and
a switch means on said gripping means for electrifying said racquet head wires and simultaneously activating the light source on said racquet head frame.

14. An apparatus according to claim 13 wherein said plurality of light sources include LEDs inset into said racquet head frame.
